(19) United States
(12) Patent Application Publication
(10) Pub. No.: US 2024/0406369 A1
(43) Pub. Date: Dec. 5, 2024

(54) LIGHT EMITTING DEVICE AND ELECTRONIC APPARATUS

(71) Applicant: Sony Group Corporation, Tokyo (JP)

(72) Inventors: Tatsuya Ichikawa, Kanagawa (JP); Katsuhide Uchino, Kanagawa (JP); Toru Nagara, Kanagawa (JP); Yoichi Hirota, Kanagawa (JP); Hisayuki Tateno, Kanagawa (JP); Naomasa Takahashi, Chiba (JP)

(21) Appl. No.: 18/690,866

(22) PCT Filed: Oct. 14, 2022
(86) PCT No.: PCT/JP22/38317

§ 371 Date: Mar. 11, 2024

(30) Foreign Application Priority Data
Oct. 29, 2021 (JP) 2021-177064

(51) Int. Cl. H04N 13/32; H04N 13/305; H04N 13/324

(52) U.S. Cl. CPC H04N 13/32; H04N 13/305; H04N 13/324

(57) ABSTRACT

There is provided a light emitting device (10) including: a light emitting surface configured by arranging a plurality of unit regions (200) in a two-dimensional array, each of the unit regions including a plurality of light emitters (202, 204); and a control unit (400) that drives the light emitters individually. Each of the unit regions includes a first light emitter and a second light emitter that emit lights having wavelengths different from each other in a near-infrared region.

### FIELD

The present disclosure relates to a light emitting device and an electronic apparatus.

### BACKGROUND

In recent years, there have been proposed methods of providing video content, each method including: imaging a subject; generating a live-action volumetric video (stereoscopic video) of a three-dimensional subject on the basis of the captured image; and enabling a viewer to view the live-action volumetric video projected or displayed at a remote location away from the subject. In such a method of providing content, since it is also possible to change a live-action volumetric video of a subject according to production effects or a viewpoint movement of a viewer, the viewer feels that the subject actually exists in front of his/her eyes. Hence, according to live-action volumetric videos, it is possible to further enhance a sense of immersion or reality felt by the viewer, as compared with conventional video content.

### CITATION LIST

### Patent Literature

Patent Literature 1: JP 2006-47069 A

### SUMMARY

### Technical Problem

In the above-described generation of a live-action volumetric video, it is necessary to prepare a plurality of imaging devices that images the subject from another viewpoint, a plurality of lighting devices (light emitting devices) that irradiate the subject with light having different wavelengths, or the like, and thus it is inevitable that a scale of a system for capturing an image will increase. In addition, in lighting devices proposed in the related art, it is difficult to perform irradiation with light having a wavelength or a pattern according to reflection characteristics or a shape of a subject or a background of the subject, and it is difficult to generate a highly accurate live-action volumetric video. Further, in the lighting devices proposed in the related art, there is a limit not only in accuracy in generating a live-action volumetric video, but also in accuracy of object detection even where the lighting devices are used for object detection such as identification of each region of an object surface or identification of a subject and a background.

Hence, the present disclosure proposes a light emitting device (lighting device) that enables highly accurate imaging (object detection) with a simple configuration.

### Solution to Problem

According to the present disclosure, there is provided a light emitting device including: a light emitting surface configured by arranging a plurality of unit regions in a two-dimensional array, each of the unit regions including a plurality of light emitters; and a control unit that drives the light emitters individually. In the light emitting device, each of the unit regions includes a first light emitter and a second light emitter that emit lights having wavelengths different from each other in a near-infrared region.

Furthermore, according to the present disclosure, there is provided an electronic apparatus equipped with a light emitting device. In the electronic apparatus, the light emitting device includes: a light emitting surface configured by arranging a plurality of unit regions in a two-dimensional array, each of the unit regions including a plurality of light emitters; and a control unit that drives the light emitters individually, and each of the unit regions includes a first light emitter and a second light emitter that emit lights having wavelengths different from each other in a near-infrared region.

### BRIEF DESCRIPTION OF DRAWINGS

FIG. 1 is a diagram for assistance in explaining an example of generation of a live-action volumetric video.

FIG. 2 is a diagram for assistance in explaining an example of a configuration of a lighting device 10 according to an embodiment of the present disclosure.

FIG. 3 is a diagram for assistance in explaining an example of a planar configuration of a block unit 200 according to the embodiment of the present disclosure.

FIG. 4 is a diagram for assistance in explaining an example of a planar configuration of a block unit 200a according to the embodiment of the present disclosure.

FIG. 5 is a diagram for assistance in explaining an example of a planar configuration of a block unit 200b according to the embodiment of the present disclosure.

FIG. 6 is a diagram for assistance in explaining an example of a planar configuration of a block unit 200c according to the embodiment of the present disclosure.

FIG. 7 is a diagram for assistance in explaining an example of a planar configuration of a block unit 200d according to the embodiment of the present disclosure.

FIG. 8 is a diagram for assistance in explaining an example of a planar configuration of a block unit 200e according to the embodiment of the present disclosure.

FIG. 9 is a diagram for assistance in explaining an example of a planar configuration of a block unit 200f according to the embodiment of the present disclosure.

FIG. 10 is a diagram for assistance in explaining an example of a planar configuration of a block unit 200g according to the embodiment of the present disclosure.

FIG. 11 is a diagram (part 1) for assistance in explaining an example of a cross-sectional configuration of the block unit 200 according to the embodiment of the present disclosure.

FIG. 12 is a diagram (part 2) for assistance in explaining an example of a cross-sectional configuration of the block unit 200 according to the embodiment of the present disclosure.

FIG. 13 is a diagram for assistance in explaining an example of an operation of a lens 300 according to the embodiment of the present disclosure.

FIG. 14 is a diagram (part 1) for assistance in explaining an example of control of a light emitting element 202 by a control unit 400 in the embodiment of the present disclosure.

FIG. 15 is a diagram (part 2) for assistance in explaining an example of control of the light emitting element 202 by the control unit 400 in the embodiment of the present disclosure.

FIG. 16 is a block diagram illustrating an example of a schematic functional configuration of a smartphone.

FIG. 17 is a view depicting an example of a schematic configuration of an endoscopic surgery system.

FIG. 18 is a block diagram depicting an example of a functional configuration of a camera head and a camera control unit (CCU).

FIG. 19 is a block diagram depicting an example of schematic configuration of a vehicle control system.

FIG. 20 is a diagram of assistance in explaining an example of installation positions of an outside-vehicle information detecting section and an imaging section.

### DESCRIPTION OF EMBODIMENTS

Hereinafter, preferred embodiments of the present disclosure will be described in detail with reference to the accompanying drawings. It is to be noted that, in this specification and the drawings, components having substantially the same functional configuration are denoted by the same reference numerals, and redundant description thereof is omitted. In addition, in this specification and the drawings, a plurality of components having substantially the same or similar functional configuration may be distinguished by attaching different letters after the same reference numerals. However, where it is not particularly necessary to distinguish each of a plurality of components having substantially the same or similar functional configuration, the same reference numerals are simply attached.

In addition, the drawings referred to in the following description are drawings for promoting the description and understanding of an embodiment of the present disclosure, and shapes, dimensions, ratios, and the like illustrated in the drawings may be different from actual ones for the sake of clarity. Further, an imaging device illustrated in the drawings can be appropriately modified in design in consideration of the following description and known technologies.

A shape described in the following description means not only a mathematically or geometrically defined shape but also a similar shape with an allowable difference (error/distortion) in an operation of a lighting device (light emitting device) and a process of manufacturing the lighting device. Further, “identical” used for a specific shape in the following description does not mean only a case of a mathematically or geometrically perfect match, but also a case of having an allowable difference (error/distortion) in the operation of the lighting device and the process of manufacturing the lighting device.

Further, in the following description, “electrically connecting” means connecting a plurality of elements directly or indirectly via another element.

It is to be noted that the description will be arranged in the following order.
1. Background to Creation of Embodiments of the Present Disclosure
2. Embodiments of the Present Disclosure
2.1 Lighting Device 10
2.2 Block Unit 200
2.3 Lens 300
2.4 Control Unit 400
3. Conclusion
4. Application Examples
4.1 Application Example to Smartphone
4.2 Application Example to Endoscopic Surgery System
4.3 Application Example to Mobile Body
5. Supplement

### 1. Background to Creation of Embodiments of the Present Disclosure

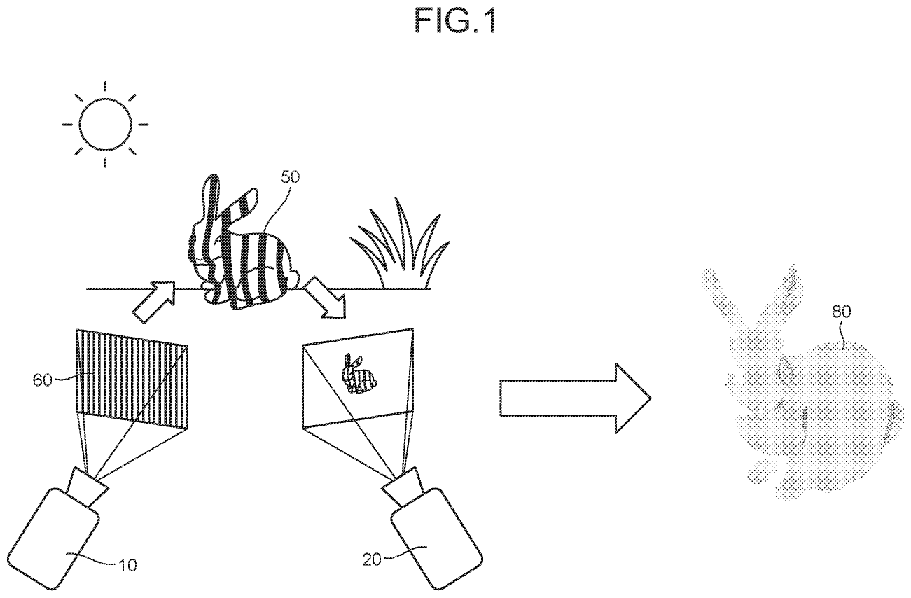

First, before details of embodiments of the present disclosure created by the present inventors are described, the background leading to the creation of the embodiments of the present disclosure by the present inventors will be described with reference to FIG. 1. FIG. 1 is a diagram for assistance in explaining an example of generation of a live-action volumetric video.

As described above, there have been proposed methods of providing video content, each method including: imaging a subject; generating a live-action volumetric video (stereoscopic video) of a three-dimensional subject on the basis of the captured image (volumetric capture technology); and enabling a viewer to view the live-action volumetric video projected or displayed at a remote location away from the subject. In such a method of providing content, since it is also possible to change a live-action volumetric video of a subject according to production effects or a viewpoint movement of a viewer, the viewer feels that the subject actually exists in front of his/her eyes. Hence, according to live-action volumetric videos, it is possible to further enhance a sense of immersion or reality felt by the viewer, as compared with conventional video content.

As the volumetric capture technology, there is a method of imaging a subject from multiple viewpoints, and stereoscopically synthesizing a plurality of captured images to generate a live-action volumetric video (stereoscopic video) of the subject. However, since the subject is imaged from multiple viewpoints, it is inevitable that a scale of a system for capturing an image will increase, and it is difficult to easily generate the live-action volumetric video.

Other examples of volumetric capture technologies include structured light. For example, as illustrated in FIG. 1, in the structured light, pattern light 60 having a predetermined pattern is projected from a lighting device 10 onto a surface of a subject 50, and a pattern of the light projected onto the subject 50 is imaged by a camera (imaging device) 20. Next, a distance to the surface of the subject 50 is estimated by analyzing deformation (a change in pattern interval, bending degree of the pattern, and the like) of the imaged light pattern. Then, by associating distance information (depth information) estimated for each pixel of an image sensor included in the camera with position information of the corresponding pixel, it is possible to obtain a stereoscopic image 80 of the subject 50 as collection of three-dimensional coordinate information in real space. Further, for example, by superimposing an image based on a visible light image of the subject 50 on the stereoscopic image 80 obtained as described above, it is possible to generate a live-action volumetric video of the subject 50. According to the structured light, since a plurality of imaging devices (cameras 20) that image the subject 50 from multiple viewpoints are not required, it is possible to avoid an increase in the scale of the system for capturing an image.

However, where the structured light is used, it is difficult to completely cancel effects of fluctuations of ambient light. For example, where the subject 50 is imaged outdoors, it is difficult to generate the stereoscopic image 80 of the subject 50 with high accuracy due to the effects of sunlight. Hence, for example, in order to avoid the effects of sunlight, it is conceivable to capture an image with light having a wide wavelength of about 1000 nm to 2000 nm by using a short wavelength infrared (SWIR) camera as the imaging device. In this case, since a plurality of individual lighting devices 10 capable of performing irradiation with light having the wavelength in the above-described wavelength band are used in combination, it is inevitable that the scale of the system for capturing an image will increase. Further, even in this case, it is difficult to change a pattern of light emitted from each lighting device 10 depending on a shape or the like of the subject 50.

In addition, where imaging is performed using one individual lighting device 10 that performs irradiation with light having a predetermined wavelength, it may be difficult to image the subject 50 and the background in an identifiable manner due to reflection characteristics of the subject 50 and the background which are targets at the predetermined wavelength. In such a case, in order to image the subject 50 and the background in an identifiable manner, it is conceivable to install a green back screen that is a monotone screen behind the subject 50. However, since a green back screen has to be always prepared, it is difficult to say that production of content by a live-action volumetric video can be easily performed.

Further, where imaging is performed using one individual lighting device 10, it may be difficult to image different regions (a face (skin) and a head (hair), for example, where the subject 50 is a face of a person) on a surface of the subject 50 in an identifiable manner, due to a difference between reflection ratios depending on the wavelength of light emitted from the lighting device 10. Hence, a plurality of individual lighting devices 10 capable of performing irradiation with light having wavelengths depending on reflection characteristics for each region desired to be identified are used in combination, but it is still inevitable that the scale of the system for capturing an image will increase.

In addition, where the plurality of lighting devices 10 are combined as described above, irradiation with light from the lighting devices 10 that are not coaxially positioned is performed with a time difference. At that time, it is difficult to perform high-speed switching control of the lighting devices 10. Therefore, in particular, where the subject 50 that changes and moves at a high speed is targeted, significant positional deviation is observed in the stereoscopic images 80 and background images obtained by the light having wavelengths, and it is difficult to generate a highly accurate live-action volumetric video.

Hence, in view of such a situation, the present inventors have created the lighting device 10 that enables highly accurate imaging (object detection) with a simple configuration. Hereinafter, the lighting device 10 according to an embodiment of the present disclosure created by the present inventors will be described in detail.

### 2. Embodiments of the Present Disclosure

### <2.1 Lighting Device 10>

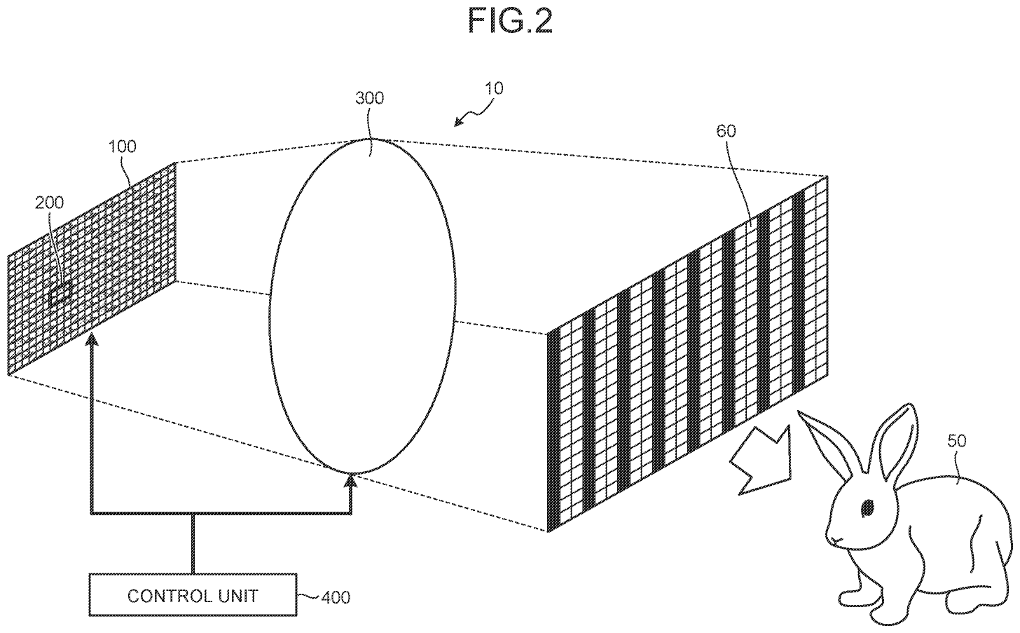

First, a configuration example of the lighting device (light emitting device) 10 according to the embodiment of the present disclosure will be described with reference to FIG. 2. FIG. 2 is a diagram for assistance in explaining an example of a configuration of the lighting device 10 according to the present embodiment. As illustrated in FIG. 2, the lighting device 10 according to the present embodiment mainly includes a light emitting unit (light emitting surface) 100, a lens (projector lens) 300, and a control unit 400 that controls the light emitting unit 100. Hereinafter, overviews of elements included in the lighting device 10 according to the present embodiment will be sequentially described.

### (Light Emitting Unit 100)

The light emitting unit 100 is configured by arranging, in a two-dimensional array, a plurality of light emitting elements (light emitters) that can emit light having different wavelengths from each other. The light emitting unit 100 can irradiate the subject 50 with light (for example, the pattern light 60 having a predetermined pattern) by emitting light from each light emitting element. In addition, in the present embodiment, a plurality of light emitting elements can be individually driven by the control unit 400 to be described below. Specifically, in the present embodiment, as illustrated in FIG. 2, the light emitting unit 100 may be configured by arranging, in a two-dimensional array on a flat surface, block units (unit regions) 200 including a predetermined number of light emitting elements.

Hence, in the present embodiment, since irradiation with light having different wavelengths can be performed using one lighting device 10, it is possible to use light depending on reflection characteristics of the surface of the subject 50 or the background, and thus it is possible to improve accuracy of identification of the subject 50 or the background. In addition, in the present embodiment, since the control unit 400 enables irradiation with lights (beams of light) having different wavelengths to be performed from one light emitting unit 100 while switching between the beams at a high speed, there is no positional deviation in the stereoscopic images 80 and the background images obtained with the lights having the wavelengths, even if the subject 50 changes and moves at a high speed. As a result, according to the present embodiment, it is possible to generate a highly accurate live-action volumetric video.

Further, in the present embodiment, since the plurality of light emitting elements are arranged in a two-dimensional array, it is possible to perform the irradiation with lights having various desired patterns depending on a size, a surface shape, and reflection characteristics of the subject 50. Hence, according to the present embodiment, the surface shape of the subject 50 can be accurately captured. It is to be noted that the light emitting unit 100 according to the present embodiment may perform irradiation with light having no pattern.

Further, in the present embodiment, the block unit 200 described above can include at least two light emitting elements (a first light emitter and a second light emitter) that can emit lights having different wavelengths from each other in a near-infrared region (850 nm to 1,500 nm). According to the present embodiment, by including the light emitting elements, it is possible to avoid the effects of sunlight by using an SWIR camera as the imaging device. It is to be noted that details of a configuration of the block unit 200 according to the present embodiment will be described below.

### (Lens 300)

A lens 300 can project light (for example, the pattern light 60 having a predetermined pattern) from the light emitting unit 100 onto the subject 50. At that time, the lens 300 can perform enlargement or reduction projection of the pattern light 60 according to a size, a distance, or the like of the subject 50, for example. It is to be noted that details of a function of the lens 300 according to the present embodiment will be described below.

### (Control Unit 400)

The control unit 400 is configured of a drive circuit and can drive (control) the light emitting elements individually as described above (active independent driving). In the present embodiment, since the light emitting elements can be individually driven by the control unit 400, the subject 50 can be irradiated with light having different wavelengths at different timings (time division) by using one lighting device 10. Hence, according to the present embodiment, for example, even where the subject 50 changes (moves) at a high speed, the subject 50 can be sequentially irradiated with the light having different wavelengths at a high speed. As a result, according to the present embodiment, since the irradiation can be performed with the lights having different wavelengths while light switch is performed at a high speed, there is no positional deviation in the stereoscopic images 80 and the background images obtained with the light having the wavelengths, and it is possible to generate a highly accurate live-action volumetric video.

In addition, in the present embodiment, since the light emitting elements can be individually driven by the control unit 400, the irradiation can be performed with lights having various wavelengths and having various patterns (predetermined patterns) from one lighting device 10. Hence, in the present embodiment, it is possible to perform irradiation with light having a suitable wavelength and pattern depending on reflection characteristics, a shape (for example, unevenness of the surface or the like), or a size of the surface of the subject 50. As a result, according to the present embodiment, the surface shape of the subject 50 can be accurately captured.

Further, in the present embodiment, the control unit 400 may control a position of the lens 300 on an optical axis. It is to be noted that details of functions of the control unit 400 according to the present embodiment will be described below.

It is to be noted that the lighting device 10 according to the present embodiment is not limited to the configuration as illustrated in FIG. 2 and may include other elements such as a plurality of lenses 300, for example.

### <2.2 Block Unit 200>

### (Planar Configurations)

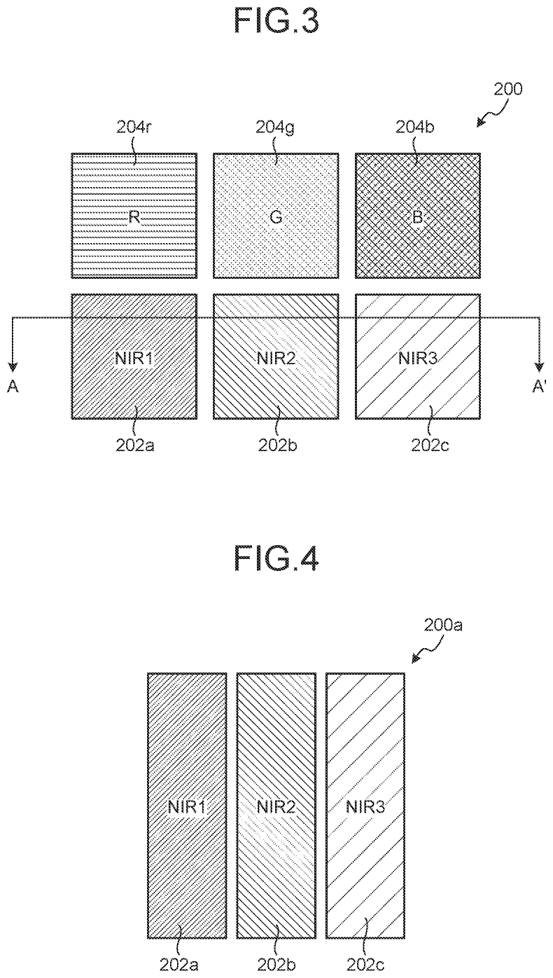

Next, a planar configuration example of the block unit 200 will be described with reference to FIGS. 3 to 10. FIG. 3 is a diagram for assistance in explaining an example of a planar configuration of a block unit 200 according to the embodiment of the present disclosure.

As described above, in the present embodiment, the light emitting unit 100 is configured by arranging, in a two-dimensional array on a flat surface, block units (unit regions) 200 including a predetermined number of light emitting elements. Further, in the present embodiment, the block unit 200 is configured by arranging the plurality of light emitting elements 202 and 204 in a two-dimensional array. The light emitting elements 202 and 204 can be formed of a light emitting diode (LED), an organic light emitting diode (OLED), a laser element configured of a semiconductor laser, a liquid crystal, or the like.

In the present embodiment, for example, as illustrated in FIG. 3, the block unit 200 is configured by, for example, arranging six light emitting elements 202 and 204 having a substantially square shape in two rows and three columns (rectangular arrangement). Specifically, the light emitting elements 202a, 202b, and 202c can emit light having a wavelength in the near-infrared region (850 nm to 1,500 nm). Specifically, for example, the light emitting element (NIR1) 202a emits light having a wavelength of 1,500 nm (specifically, light having an intensity distribution with a peak in the vicinity of 1,500 nm, the same applies to the following description in this specification), the light emitting element (NIR2) 202b emits light having a wavelength of 1,200 nm, and the light emitting element (NIR3) 202c emits light having a wavelength of 940 nm.

Further, the light emitting elements (fourth light emitters) 204b, 204g, and 204r can emit light having a wavelength in the visible light region (360 nm to 830 nm). Specifically, for example, the light emitting element (B) 204b emits blue light (for example, a wavelength of 450 nm to 495 nm), the light emitting element (G) 204g emits green light (for example, a wavelength of 495 nm to 570 nm), and the light emitting element (R) 204r emits red light (for example, a wavelength of 620 nm to 750 nm). It is to be noted that, in the present embodiment, one or a plurality of the light emitting elements 204 that emit light having the wavelengths in the visible light region (360 nm to 830 nm) may be included in the block unit 200, and the number of the light emitting elements is not particularly limited.

As described above, in the present embodiment, by combining the light emitting elements 202 that can emit the light having the wavelengths in the near-infrared region and the light emitting elements 204 that can emit the light having the wavelengths in the visible light region, it is possible to improve the accuracy of detection (recognition) of the subject 50 and the like having reflection characteristics that cannot be covered by light having wavelengths in the near-infrared region.

It is to be noted that, in the present embodiment, the block unit 200 may include a light emitting element (not illustrated) that emits light having a wavelength of 1,500 nm or longer in an infrared region. In this manner, since light in a wider band can be emitted by one lighting device 10, the accuracy of detection (recognition) of the subject 50 or the like can be improved.

In addition, in the present embodiment, the light emitting elements 202 and 204 are not limited to emitting light having the above-described wavelengths, and at least the block unit 200 may include two light emitting elements (the first light emitter and the second light emitter) 202 that can emit lights having different wavelengths from each other in the near-infrared region. It is to be noted that, in the example illustrated in FIG. 3, it can be observed that the block unit 200 includes three light emitting elements (a first light emitter, a second light emitter, and a third light emitter) 202 that can emit lights having different wavelengths from each other in the near-infrared region. In addition, in the example illustrated in FIG. 3, it can be observed that the block unit 200 includes three light emitting elements (fourth light emitters) 204 that can emit light having different wavelengths from each other in the visible light region.

That is, in the present embodiment, the configuration of the block unit 200 is not limited to the configuration illustrated in FIG. 3 and can be variously modified. Hence, various configuration examples of the block unit 200 will be described with reference to FIGS. 4 to 10. FIGS. 4 to 10 are diagrams for assistance in explaining examples of planar configurations of the block unit 200 according to the present embodiment.

For example, in the example illustrated in FIG. 4, a block unit 200a is configured by arranging three vertically long and substantially rectangular light emitting elements 202 in one row and three columns (stripe arrangement). In the example of FIG. 4, the light emitting elements 202a, 202b, and 202c can emit light having wavelengths in the near-infrared region. Specifically, for example, the light emitting element (NIR1) 202a emits light having a wavelength of 1,500 nm, the light emitting element (NIR2) 202b emits light having a wavelength of 1,200 nm, and the light emitting element (NIR3) 202c emits light having a wavelength of 940 nm.

It is to be noted that, in the present embodiment, the planar shape of the light emitting elements 202 is not limited to the substantially square shape or the vertically long and substantially rectangular shape and may be, for example, a horizontally long and substantially rectangular shape, a substantially circular shape, or a substantially polygonal shape (for example, a substantially triangular shape). Further, in the present embodiment, as in the example illustrated in FIG. 4, the block unit 200a may be configured of only the light emitting element 202 that can emit light having a wavelength in the near-infrared region.

For example, in the example illustrated in FIG. 5, a block unit 200b is configured by arranging four vertically long and substantially rectangular light emitting elements 202 in one row and four columns. In the example of FIG. 5, the light emitting elements 202a, 202b, 202c, and 202d can emit light having wavelengths in the near-infrared region. Specifically, for example, the light emitting element (NIR1) 202a emits light having a wavelength of 1,500 nm, the light emitting element (NIR2) 202b emits light having a wavelength of 1,200 nm, the light emitting element (NIR3) 202c emits light having a wavelength of 940 nm, and further the light emitting element (NIR4) 202d emits light having a wavelength of 850 nm. That is, in the present embodiment, the block unit 200 can include a plurality of light emitting elements 202 that can emit lights having different wavelengths from each other in the near-infrared region.

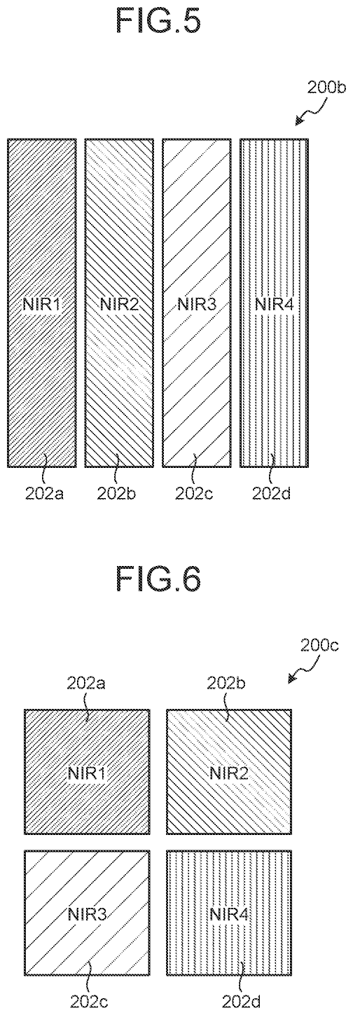

In addition, for example, in the example illustrated in FIG. 6, the block unit 200c is configured by arranging four substantially square light emitting elements of a light emitting element (NIR1) 202a, a light emitting element (NIR2) 202b, a light emitting element (NIR3) 202c, and a light emitting element (NIR4) 202d in two rows and two columns (square arrangement). It is to be noted that, in the present embodiment, the arrangement of the plurality of light emitting elements 202 and 204 in the block unit 200 is not limited to the rectangular arrangement in which the light emitting elements 202 and 204 are arranged to form a rectangle, the square arrangement in which the light emitting elements are arranged to form a square, or the stripe arrangement in which the light emitting elements are arranged in a stripe shape. In the present embodiment, for example, polygonal arrangement (for example, honeycomb arrangement, delta arrangement, or the like) in which the plurality of light emitting elements 202 and 204 in the block unit 200 are arranged to form a polygon or substantially circular arrangement (for example, circular arrangement, elliptical arrangement, or the like) may be employed.

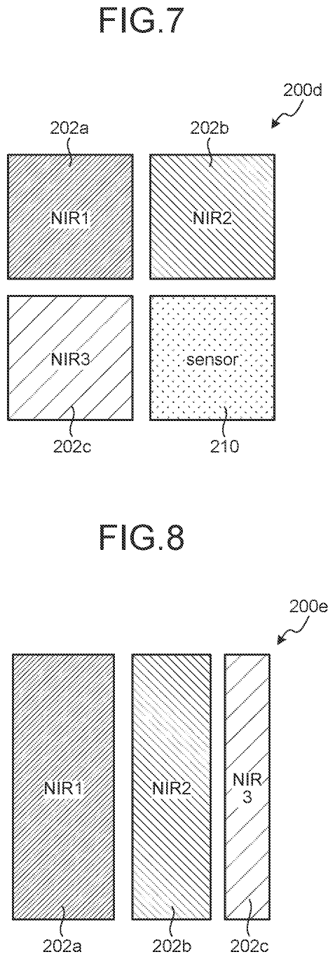

In addition, in the present embodiment, the block unit 200 is not limited to including only the light emitting elements 202 and 204 and may include, for example, a sensor (sensor element) 210. In addition, for example, in the example illustrated in FIG. 7, a block unit 200d is configured by arranging three substantially square light emitting elements of a light emitting element (NIR1) 202a, a light emitting element (NIR2) 202b, and a light emitting element (NIR3) 202c, and a substantially square sensor 210 in two rows and two columns (square arrangement). The sensor 210 can be, for example, a sensor that receives reflected light obtained by reflection of the light from the lighting device 10 from the subject 50. More specifically, the sensor 210 can be, for example, an image sensor such as a near infrared (SWIR) sensor, a visible light sensor, an infrared sensor, or an event-based vision sensor (EVS).

Although the block unit 200d includes one sensor 210 in the example illustrated in FIG. 7, the block unit may include a plurality of sensors 210 of the same type or different types in the present embodiment. In the present embodiment, since the block unit 200 includes the sensor 210, the lighting device 10 and the imaging device (camera 20) can be integrated, and thus an imaging system can be made more compact. It is to be noted that, in the present embodiment, the subject 50 may be imaged using the imaging device (camera 20) including the above-described various sensors, the imaging device being a device separate from the lighting device 10.

In addition, in the examples described above, all of the light emitting elements 202 and 204 only have the same area and shape in plan view, but in the present embodiment, the light emitting elements 202 and 204 may have different areas and shapes in plan view. In addition, for example, in the example illustrated in FIG. 8, a block unit 200e is configured by arranging three vertically long and substantially square light emitting elements of a light emitting element (NIR1) 202a, a light emitting element (NIR2) 202b, and a light emitting element (NIR3) 202c in one row and three columns (stripe arrangement). Further, in the example illustrated in FIG. 8, areas of the three light emitting elements 202a, 202b, and 202c are different from each other. The light emitting element 202a has the widest area, and the light emitting element 202c has the narrowest area. In the present embodiment, the light emitting elements 202 and 204 have different areas as described above, so that irradiation with lights having respective wavelengths can be performed with suitable intensity (light amount) depending on the reflection characteristics of the surface of the subject 50.

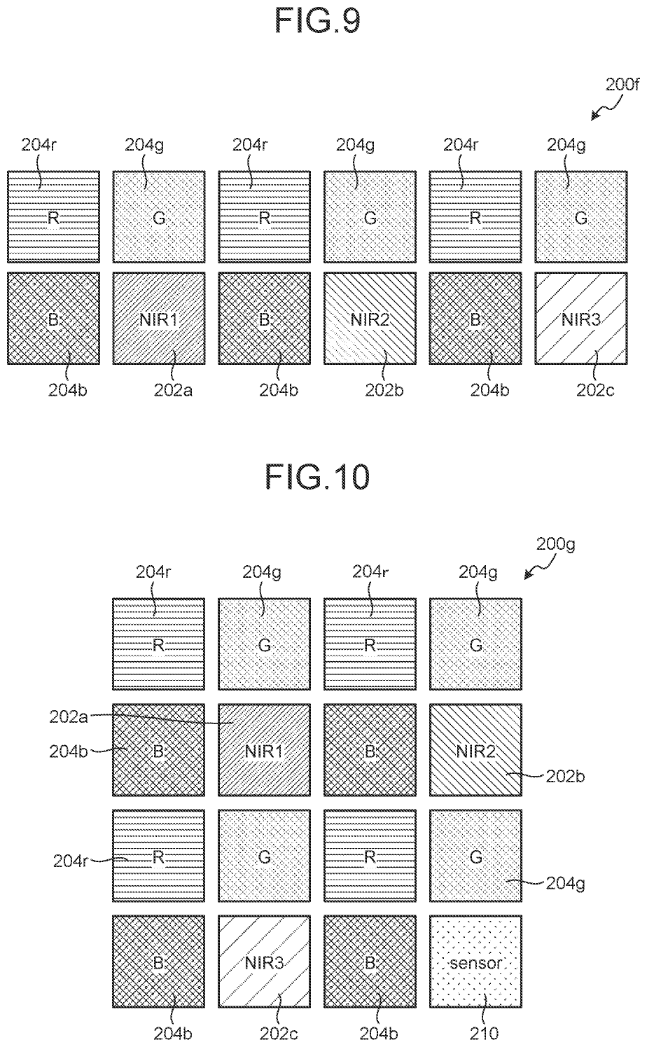

In addition, for example, in the example illustrated in FIG. 9, a block unit 200f is configured by arranging twelve substantially square light emitting elements 202 and 204 in two rows and six columns (rectangular arrangement). Specifically, as illustrated in FIG. 9, three light emitting elements 204b, 204g, and 204r that can emit light having wavelengths in the visible light region are arranged for each light emitting element 202 (specifically, the light emitting element (NIR1) 202a, the light emitting element (NIR2) 202b, and the light emitting element (NIR3) 202c) that emit the light having the wavelength in the near-infrared region. That is, in the example illustrated in FIG. 9, the light emitting elements 202 and 204 are arranged such that a distribution of the light emitting elements 202 that emit the light having the wavelengths in the near-infrared region is smaller than that of the light emitting elements 204 that can emit the light having the wavelengths in the visible light region (in other words, the light emitting elements 202 that emit the light having the wavelengths in the near-infrared region are thinned out and arranged). In the present embodiment, the distributions of the light emitting elements 202 and 204 are different as described above, so that irradiation with lights having respective wavelengths can be performed with suitable intensity (light amount) depending on the reflection characteristics of the surface of the subject 50.

It is to be noted that, in the present embodiment, the arrangement of the light emitting elements 202 and 204 is not limited to the arrangement in which the distribution of the light emitting elements 202 that emit the light having the wavelengths in the near-infrared region is smaller than that of the light emitting elements 204 that can emit the light having the wavelengths in the visible light region. In the present embodiment, for example, the light emitting elements 202 and 204 may be arranged such that the distribution of the light emitting elements 202 that emit the light having the wavelengths in the near-infrared region is larger than that of the light emitting elements 204 that can emit the light having the wavelengths in the visible light region. Alternatively, for example, the light emitting elements 202 and 204 may be arranged such that the distribution of the light emitting elements 202 that emit the light having the wavelengths in the near-infrared region is equal to that of the light emitting elements 204 that can emit the light having the wavelengths in the visible light region.

In addition, for example, in the example illustrated in FIG. 10, a block unit 200g is configured by arranging sixteen substantially square light emitting elements 202 and 204, and sensor 210 in four rows and four columns (square arrangement). Specifically, as illustrated in FIG. 10, three light emitting elements 204b, 204g, and 204r that can emit the light having the wavelengths in the visible light region are arranged for the sensor 210 or each light emitting element 202 (specifically, the light emitting element (NIR1) 202a, the light emitting element (NIR2) 202b, and the light emitting element (NIR3) 202c) that emits the light having the wavelength in the near-infrared region. It is to be noted that, in the example illustrated in FIG. 10, the light emitting element 202d or the like that emits the light having the wavelength of 850 nm may be arranged instead of the sensor 210.

As described above, in the present embodiment, the configuration of the block unit 200 can be variously modified. It is to be noted that, in the present embodiment, the planar configuration of the block unit 200 is not limited to the examples illustrated in FIGS. 3 to 10.

### (Cross-Sectional Configurations)

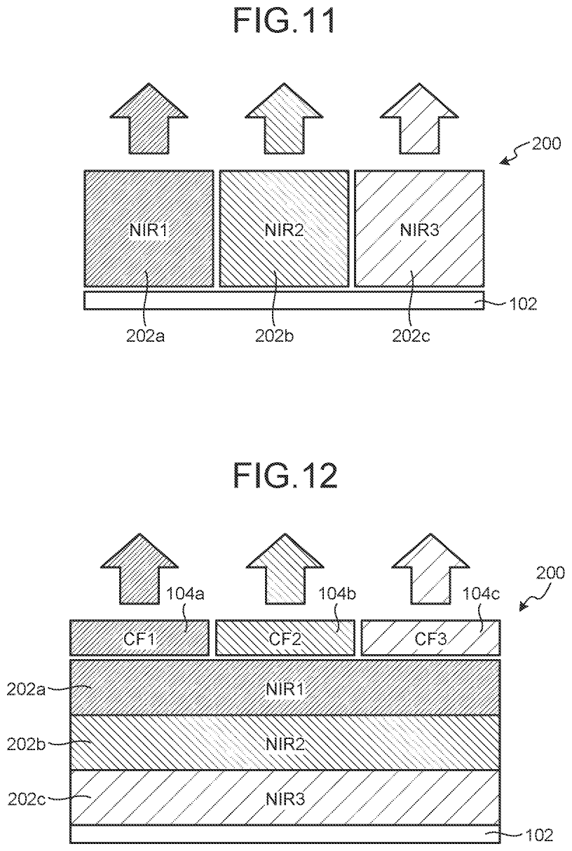

Next, cross-sectional configuration examples of the block unit 200 will be described with reference to FIGS. 11 and 12. FIGS. 11 and 12 are diagrams for assistance in explaining an example of a cross-sectional configuration of the block unit 200 according to the present embodiment and specifically correspond to a cross-sectional view of the block unit 200 taken along line A-A′ in FIG. 3.

For example, in the example illustrated in FIG. 11, the light emitting element (NIR1) 202a that emits the light having the wavelength of 1,500 nm, the light emitting element (NIR2) 202b that emits the light having the wavelength of 1,200 nm, and the light emitting element (NIR3) 202c that emits the light having the wavelength of 940 nm are provided adjacent to each other on a substrate 102 (specifically, on the same surface of the substrate 102). In the present embodiment, employment of the cross-sectional configuration enables the configuration of the lighting device 10 to be simplified and the manufacturing of the lighting device 10 to be facilitated.

It is to be noted that, as described above, in the present embodiment, the block unit 200 may include at least two light emitting elements (the first light emitter and the second light emitter) 202 that can emit lights having different wavelengths from each other in the near-infrared region. Hence, in the present embodiment, the two light emitting elements (the first light emitter and the second light emitter) 202 that can emit lights having different wavelengths from each other in the near-infrared region can be provided adjacent to each other on the substrate 102.

In addition, the present embodiment is not limited to a structure in which the light emitting elements 202a, 202b, and 202c are provided adjacent to each other on the substrate 102 as in the example illustrated in FIG. 10. In the present embodiment, for example, in addition to the light emitting elements 202a, 202b, and 202c, the light emitting element 202d that emits the light having the wavelength of 850 nm, the light emitting element 204 that can emit the light having the wavelength in the visible light region, or the sensor 210 may be similarly provided on the substrate 102.

In addition, in the present embodiment, the light emitting elements 202 may be stacked on each other on the substrate 102. For example, in the example illustrated in FIG. 12, the light emitting element (NIR3) 202c that emits the light having the wavelength of 940 nm, the light emitting element (NIR2) 202b that emits the light having the wavelength of 1, 200 nm, and the light emitting element (NIR1) 202a that emits the light having the wavelength of 1,500 nm are sequentially stacked on the substrate 102. Further, in the example illustrated in FIG. 12, three color filters 104a, 104b, and 104c are provided adjacent to each other on the uppermost light emitting element (NIR1) 202a (specifically, on the same surface of the light emitting element 202a).

Specifically, for example, the color filter 104a can selectively transmit light having a wavelength in the vicinity of 1,500 nm, the color filter 104b can selectively transmit light having a wavelength in the vicinity of 1,200 nm, and the color filter 104c can selectively transmit light having a wavelength in the vicinity of 940 nm. In the example illustrated in FIG. 12, by providing the color filters 104a, 104b, and 104c adjacent to each other on the stacked layers of the light emitting elements 202a, 202b, and 202c, light having a different wavelength can be emitted for each zone on the flat surface of the block unit 200. In the present embodiment, by employing the cross-sectional configuration, it is necessary to provide the color filters 104, but even where it is difficult to form the fine light emitting elements 202 due to process capability, a plurality of fine zones that can emit lights having different wavelengths can be formed on the block unit 200.

As described above, in the present embodiment, the block unit 200 may include at least two light emitting elements (the first light emitter and the second light emitter) 202 that can emit lights having different wavelengths from each other in the near-infrared region. Hence, in the present embodiment, the two light emitting elements (the first light emitter and the second light emitter) 202 that can emit lights having different wavelengths from each other in the near-infrared region can be provided to be stacked on each other on the substrate 102.

In addition, the present embodiment is not limited to a structure in which the light emitting elements 202a, 202b, and 202c are provided to be stacked on each other on the substrate 102 as in the example illustrated in FIG. 11. In the present embodiment, for example, in addition to the light emitting elements 202a, 202b, and 202c, the light emitting element 202d that emits the light having the wavelength of 850 nm or the light emitting element 204 that can emit the light having the wavelength in the visible light region may be similarly provided to be stacked on each other on the substrate 102. In this case, the color filters 104 that transmit beams of light at a predetermined wavelength band is provided adjacent to each other on the stacked layers.

It is to be noted that, in the present embodiment, the cross-sectional configuration of the block unit 200 is not limited to the example illustrated in FIGS. 11 and 12, and another layer may be stacked, for example.

### <2.3 Lens 300>

As described above, the lighting device 10 according to the present embodiment may include the lens (projector lens) 300. The lens 300 is formed of glass, resin, or the like and can project the pattern light 60 from the light emitting unit 100 onto the subject 50. It is to be noted that, in the example illustrated in FIG. 2, the lens 300 is illustrated as one convex lens, but in the present embodiment, the lens 300 may be configured by combining a plurality of lenses including zoom lenses or focus lenses.

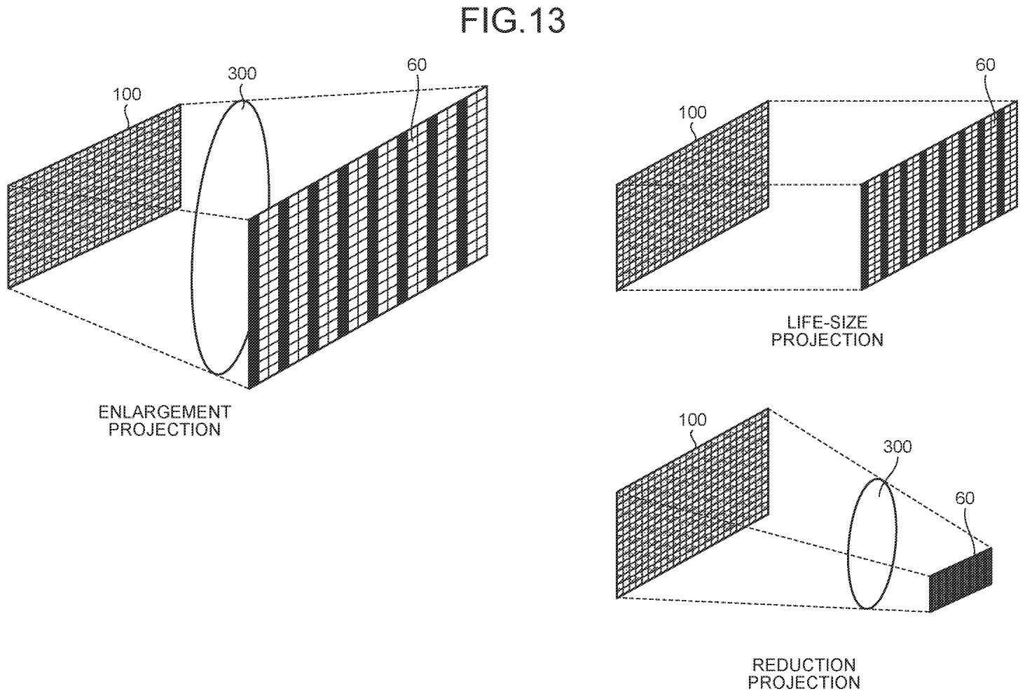

Specifically, as illustrated in FIG. 13 that is a diagram for assistance in explaining an example of an operation of the lens 300 according to the present embodiment, the lens 300 can perform enlargement projection or reduction projection of the pattern light 60 depending on a size, a distance, or the like of the subject 50, for example. In addition, the light from the light emitting unit 100 may be projected onto the subject 50 at life-size projection. In this case, as illustrated in FIG. 13, the lens 300 may not be provided.

Further, in the present embodiment, the position of the lens 300 on the optical axis may be controlled by the control unit 400 for adjustment or the like of the magnification and focus of the pattern light 60. Under the control of the control unit 400, the lens 300 can perform enlargement projection or reduction projection of the pattern light 60.

### <2.4 Control Unit 400>

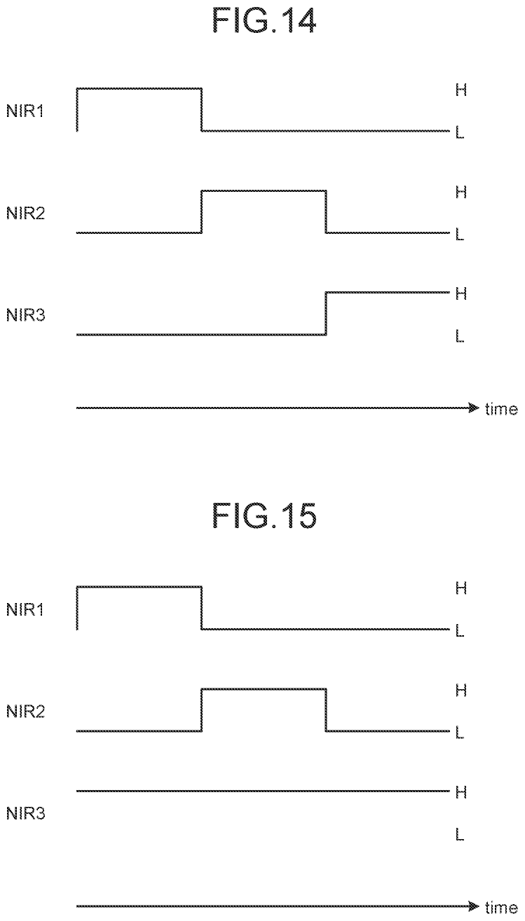

Next, the control unit 400 according to the present embodiment will be described with reference to FIGS. 14 and 15. FIGS. 14 and 15 are diagrams for assistance in explaining an example of control of the light emitting element 202 by the control unit 400 in the present embodiment.

As described above, the control unit 400 is configured of a drive circuit and can drive (control) the light emitting elements 202 and 204 individually (active independent driving). Specifically, in the control unit 400, an active element (drive element) is provided for each of the light emitting elements 202 and 204, and each of the light emitting elements (light emitters) 202 and 204 can be individually driven by turning on/off the active elements. In addition, in the present embodiment, since the light emitting elements 202 and 204 can be individually driven, the subject 50 can be irradiated with the pattern light 60 using one lighting device 10 with lights having various wavelengths and having various patterns. As a result, in the present embodiment, it is possible to perform irradiation with the pattern light 60 having a suitable wavelength and pattern depending on reflection characteristics, a shape (for example, unevenness of the surface or the like), or a size of the surface of the subject 50. Examples of the pattern of the pattern light 60 include a stripe shape, a lattice shape, a dot shape (for example, a plurality of cross patterns arranged at predetermined intervals), and the like. Further, in the present embodiment, not only the shape of the pattern light 60 but also the intervals or the like between the patterns can be appropriately changed.

In addition, in the present embodiment, the control unit 400 can control the light emitting elements (light emitters) 202 and 204 to irradiate the subject 50 with the light having different wavelengths at different timings (time-divisional driving). For example, as illustrated in FIG. 14, the control unit 400 can control, for example, the light emitting element NIR1 that emits the beam of light having the wavelength of 1500 nm, the light emitting element NIR2 that emits the beam of light having the wavelength of 1200 nm, and the light emitting element NIR3 that emits the beam of light having the wavelength of 940 nm to emit the beams of light at different timings. It is to be noted that, in the example illustrated in FIG. 14, the light emitting element is controlled to emit light in the case of H, and the light emitting element is controlled to be turned off in the case of L (the same applies to FIG. 15). In addition, in the example illustrated in FIG. 14, control of the light emitting elements 202 that can emit the beams of light having the wavelengths in the near-infrared region by the control unit 400 is illustrated. However, in the present embodiment, similarly to the light emitting elements 202, the control unit 400 can also control the light emitting elements 204 or the like that can emit the beams of light having the wavelengths in the visible light region.

Hence, in the present embodiment, since the control unit 400 enables the irradiation with the lights having different wavelengths to be performed from one light emitting unit 100 while switching between the beams, it is possible to image the subject 50 and the background in an identifiable manner or image different regions (for example, a face (skin) and a head (hair) where the subject 50 is a face of a person) of the surface of the subject 50 in an identifiable manner. Further, in the present embodiment, since the control unit 400 enables the irradiation to be performed with the lights having different wavelengths while switching between the beams at a high speed, there is no positional deviation in the stereoscopic images 80 and the background images obtained with the lights having the wavelengths, even if the subject 50 changes and moves at a high speed. As a result, according to the present embodiment, it is possible to generate a highly accurate live-action volumetric video.

In addition, in the present embodiment, the control unit 400 can control the light emitting elements (light emitters) 202 and 204 to perform the irradiation with the lights having different wavelengths at the same timings (predetermined period of time). For example, as illustrated in FIG. 15, the control unit 400 can control, for example, the light emitting element NIR1 that emits the beam of light having the wavelength of 1500 nm and the light emitting element NIR2 that emits the beam of light having the wavelength of 1200 nm to emit the beams of light at different timings from each other. Further, the control unit 400 controls the light emitting element NIR3 that emits the beam of light having the wavelength of 940 nm to emit the beam of light at the same timing as the light emitting element NIR1 or the light emitting element NIR2. In this manner, in the present embodiment, the brightness of light in a predetermined wavelength region may be increased. It is to be noted that, in the example illustrated in FIG. 15, the control of the light emitting elements 202 that can emit the lights having the wavelengths in the near-infrared region by the control unit 400 is illustrated. However, in the present embodiment, similarly to the light emitting elements 202, the control unit 400 can also control the light emitting elements 204 or the like that can emit the lights having the wavelengths in the visible light region.

Further, in the present embodiment, as described above, the control unit 400 may control the position of the lens 300 on the optical axis for adjustment or the like of the magnification and focus of the pattern light 60.

### 3. Conclusion

As described above, according to the embodiment of the present disclosure, it is possible to propose the lighting device 10 that enables highly accurate imaging (object detection) with a simple configuration.

Specifically, according to the present embodiment, since the irradiation with the lights having different wavelengths and different patterns can be performed using one lighting device 10, the lights having wavelengths or patterns can be used to correspond to the reflection characteristics of the surface of the subject 50 or the background without preparing a plurality of lighting devices 10 and a green back screen. As a result, in the present embodiment, the accuracy of identification (imaging) of the subject 50 and the background can be improved with a simple configuration.

In addition, in the present embodiment, since the control unit 400 enables irradiation with lights having different wavelengths to be performed from one light emitting unit 100 while switching between the beams at a high speed, there is no positional deviation in the stereoscopic images 80 and the background images obtained with the lights having the wavelengths, even if the subject 50 changes and moves at a high speed. As a result, according to the present embodiment, it is possible to generate a highly accurate live-action volumetric video.

In addition, in the present embodiment, since the lighting device 10 can emit the lights having the different wavelengths from each other at least in the near-infrared region, it is possible to perform imaging while avoiding the effects of sunlight by using the SWIR camera as the imaging device.

In addition, the lighting device 10 according to the embodiment of the present disclosure can be manufactured by using a method, an apparatus, and a condition used for manufacturing a general semiconductor device. That is, the light emitting unit 100 and the control unit 400 of the lighting device 10 according to the present embodiment can be manufactured using a process of manufacturing an existing semiconductor device.

It is to be noted that examples of the above-described method include a physical vapor deposition (PVD) method, a chemical vapor deposition (CVD) method, an atomic layer deposition (ALD) method, and the like. Examples of the PVD method include a vacuum deposition method, an electron beam (EB) evaporation method, various sputtering methods (a magnetron sputtering method, a radio frequency (RF)-direct current (DC) coupled bias sputtering method, an electron cyclotron resonance (ECR) sputtering method, a facing target sputtering method, a high frequency sputtering method, and the like), an ion plating method, a laser ablation method, a molecular beam epitaxy (MBE) method, and a laser transfer method. In addition, examples of the CVD method include a plasma CVD method, a thermal CVD method, an organic metal (MO) CVD method, and a photo CVD method. Further, other methods include an electrolytic plating method, an electroless plating method, or a spin coating method; a dipping method; a casting method; a micro-contact printing method; a drop casting method; various printing methods such as a screen printing method, an inkjet printing method, an offset printing method, a gravure printing method, or a flexographic printing method; a stamping method; a spray method; or various coating methods such as an air doctor coater method, a blade coater method, a rod coater method, a knife coater method, a squeeze coater method, a reverse roll coater method, a transfer roll coater method, a gravure coater method, a kiss coater method, a cast coater method, a spray coater method, a slit orifice coater method, or a calender coater method. Further, examples of patterning methods include chemical etching using a shadow mask, laser transfer, or photolithography, and physical etching using ultraviolet rays, laser, or the like. In addition, examples of a planarization technique include a chemical mechanical polishing (CMP) method, a laser planarization method, a reflow method, and the like.

### 4. Application Examples

The technology according to the present disclosure (the present technology) can be applied to various uses other than the generation of a live-action volumetric video.

According to the technology of the present disclosure, the lighting device 10 can perform the irradiation with the lights having different wavelengths from each other in the near-infrared region. Since the light having a wavelength in the near-infrared region has a high reflection ratio by the human skin, it is possible to accurately detect human skin by using two lights having different wavelengths as described above by applying the technology of the present disclosure. In addition, the human skin has various colors such as white, blackish brown, and intermediate colors therebetween. However, according to the technology of the present disclosure, since the irradiation with a plurality of lights having different wavelengths in the near-infrared region can be performed, the human skin can be detected with high accuracy.

Further, according to the technology of the present disclosure, since the human skin can be detected with high accuracy, the technology of the present disclosure can also be applied to detection of a human face or a facial orientation (detection of a driver's state in automobile driving assistance or detection of an operation an apparatus or the like), face authentication, medical examination (diagnosis of health condition of skin, etc.), or a beauty apparatus (suggestion of cosmetics by determination of a skin color, etc.). In addition, the technology of the present disclosure can also be applied to estimation of a psychological/mental state of a human since a small change in facial expression of a human can be detected.

In addition, according to the technology of the present disclosure, since a plurality of lights having different wavelengths can be used depending on the reflection characteristics of the subject 50 to be detected, the lighting device 10 according to the technology of the present disclosure can be used as a lighting device when detecting a difference in a small subject 50 or a small shape, or the like that is difficult to detect under visible light or the like. Specifically, the technology of the present disclosure can be applied to medical inspection or shipment inspection in a manufacturing process of food, medicine, or the like. Further, the technology of the present disclosure can also be applied to lighting for a sensor mounted on an autonomous robot, an autonomous vehicle, or the like, which is required to detect a surrounding situation in detail. In addition, the technology of the present disclosure can also be applied to a user interface (UI) that can detect a minute movement (movement of a line of sight) of a human eyeball and perform an input operation according to the line of sight, a sensor that detects a minute movement of an eyeball and detects a human awakening state, or the like (for example, mounted on an automobile).

### <4.1 Application Example to Smartphone>

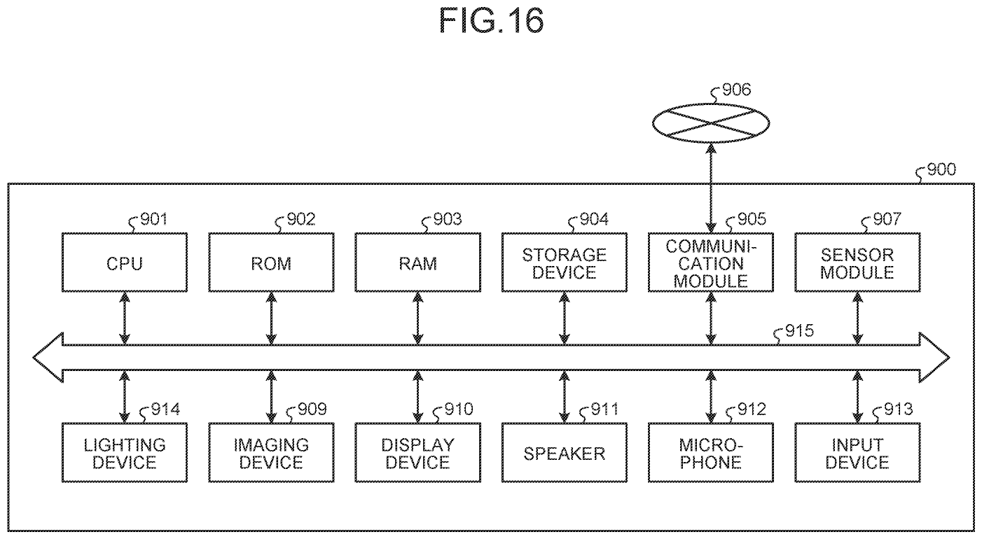

For example, the technology according to the present disclosure may be applied to a smartphone or the like. Therefore, a configuration example of a smartphone 900 as an electronic apparatus to which the present technology is applied will be described with reference to FIG. 16. FIG. 16 is a block diagram illustrating an example of a schematic functional configuration of the smartphone 900 to which the technology according to the present disclosure (the present technology) can be applied.

As illustrated in FIG. 16, the smartphone 900 includes a central processing unit (CPU) 901, a read only memory (ROM) 902, and a random access memory (RAM) 903. In addition, the smartphone 900 includes a storage device 904, a communication module 905, and a sensor module 907. Further, the smartphone 900 includes an imaging device 909, a display device 910, a speaker 911, a microphone 912, an input device 913, a lighting device 914, and a bus 915. In addition, the smartphone 900 may include a processing circuit such as a digital signal processor (DSP) instead of or in addition to the CPU 901.

Hence, the CPU 901 functions as an arithmetic processing device and a control device and controls an overall operation in the smartphone 900 or a part thereof according to various programs recorded in the ROM 902, the RAM 903, the storage device 904, or the like. The ROM 902 stores programs, calculation parameters, or the like used by the CPU 901. The RAM 903 primarily stores programs used in the execution of the CPU 901, parameters that appropriately change in the execution thereof, or the like. The CPU 901, the ROM 902, and the RAM 903 are connected to one another by the bus 915. In addition, the storage device 904 is a data storing device configured as an example of a storage unit of the smartphone 900. The storage device 904 is configured of, for example, a magnetic storage device such as a hard disk drive (HDD), a semiconductor storage device, an optical storage device, or the like. The storage device 904 stores programs and various items of data executed by the CPU 901, various items of data acquired from the outside, or the like.

The communication module 905 is a communication interface configured of, for example, a communication device for connecting to the communication network 906 or the like. The communication module 905 can be, for example, a communication card or the like for wired or wireless local area network (LAN), Bluetooth (registered trademark), wireless USB (WUSB). In addition, the communication module 905 may be a router for optical communication, a router for asymmetric digital subscriber line (ADSL), a modem for various types of communication, or the like. The communication module 905 transmits and receives signals or the like to and from the Internet or another communication apparatus using a predetermined protocol such as Transmission Control Protocol (TCP)/Internet Protocol (IP). In addition, the communication network 906 connected to the communication module 905 is a network connected in a wired or wireless manner and is, for example, the Internet, a home LAN, infrared communication, satellite communication, or the like.

The sensor module 907 includes, for example, various sensors such as a motion sensor (for example, an acceleration sensor, a gyro sensor, a geomagnetic sensor, or the like), a biological information sensor (for example, a pulse sensor, a blood pressure sensor, a fingerprint sensor, or the like), or a position sensor (for example, a global navigation satellite system (GNSS) receiver or the like).

The imaging device 909 is provided on a front surface of the smartphone 900 and can image an object or the like located on a back side or a front side of the smartphone 900. Specifically, the imaging device 909 may include an image pickup element (not illustrated) such as a complementary MOS (CMOS) image sensor to which the technology according to the present disclosure (present technology) can be applied and a signal processing circuit (not illustrated) that performs imaging signal processing on a signal photoelectrically converted by the image pickup element. Further, the imaging device 909 can further include an optical system mechanism (not illustrated) configured of an imaging lens, a zoom lens, a focus lens, and the like, and a drive system mechanism (not illustrated) that controls an operation of the optical system mechanism. Then, the image pickup element collects, as an optical image, incident light from an object, and the signal processing circuit photoelectrically can convert the formed optical image in units of pixels, can read a signal of each pixel as an imaging signal, and can perform image processing to acquire a captured image.

The display device 910 is provided on a surface of the smartphone 900 and can be, for example, a display device such as a liquid crystal display (LCD) or an organic electro luminescence (EL) display. The display device 910 can display an operation screen, a captured image acquired by the above-described imaging device 909, or the like.

The speaker 911 can output, for example, a call voice, a voice accompanying video content displayed by the display device 910 described above, or the like to the user.

The microphone 912 can collect, for example, a call voice of the user, a voice including a command to activate a function of the smartphone 900, and a voice in a surrounding environment of the smartphone 900.

The input device 913 is a device operated by the user, such as a button, a keyboard, a touch panel, or a mouse. The input device 913 includes an input control circuit that generates an input signal on the basis of information input by the user and outputs the input signal to the CPU 901. The user operates the input device 913, thereby enabling various data to be input to the smartphone 900 and a processing operation to be instructed.

The lighting device 914 can irradiate a subject with light having a predetermined wavelength when imaging the subject with the imaging device 909 described above. Specifically, the technology of the present disclosure can be applied to the lighting device 914.

The configuration example of the smartphone 900 has been described above. By using the smartphone 900, it is possible to easily generate a live-action volumetric video. Each of the above-described components may be configured using a general-purpose member or may be configured of hardware specialized for the function of each component. Such a configuration can be appropriately changed according to a technical level at the time of implementation.

### <4.2 Application Example to Endoscopic Surgery System>

For example, the technology according to the present disclosure may be applied to an endoscopic surgery system.

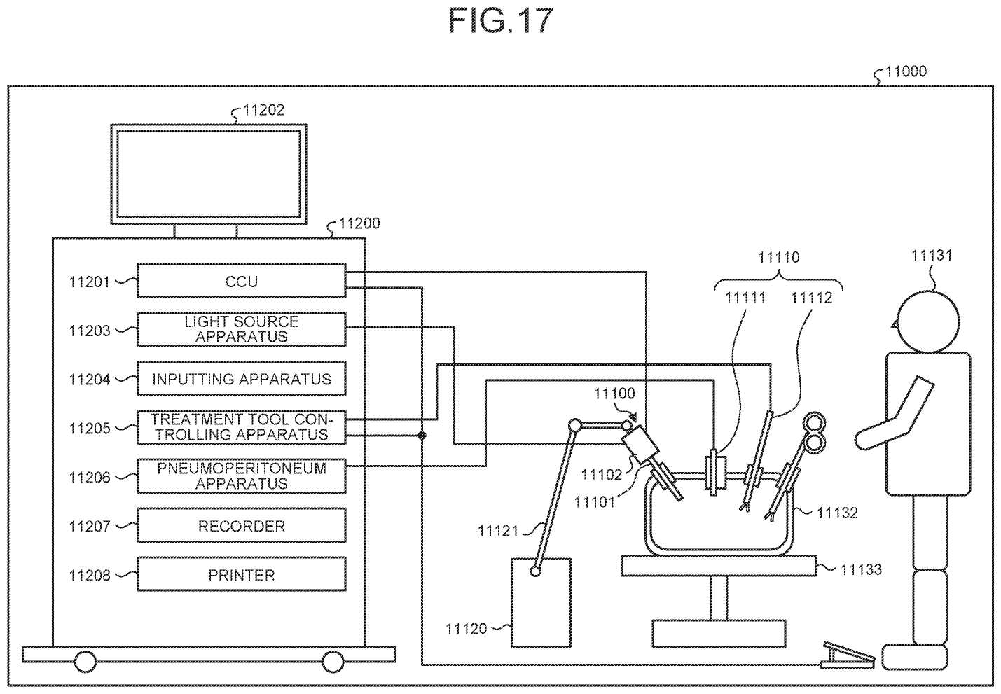

FIG. 17 is a view depicting an example of a schematic configuration of an endoscopic surgery system to which the technology according to an embodiment of the present disclosure (present technology) can be applied.

In FIG. 17, a state is illustrated in which a surgeon (medical doctor) 11131 is using an endoscopic surgery system 11000 to perform surgery for a patient 11132 on a patient bed 11133. As depicted, the endoscopic surgery system 11000 includes an endoscope 11100, other surgical tools 11110 such as a pneumoperitoneum tube 11111 and an energy treatment tool 11112, a supporting arm apparatus 11120 which supports the endoscope 11100 thereon, and a cart 11200 on which various apparatus for endoscopic surgery are mounted.

The endoscope 11100 includes a lens barrel 11101 having a region of a predetermined length from a distal end thereof to be inserted into a body lumen of the patient 11132, and a camera head 11102 connected to a proximal end of the lens barrel 11101. In the example depicted, the endoscope 11100 is depicted which includes as a hard mirror having the lens barrel 11101 of the hard type. However, the endoscope 11100 may otherwise be included as a soft mirror having the lens barrel 11101 of the soft type.

The lens barrel 11101 has, at a distal end thereof, an opening in which an objective lens is fitted. A light source apparatus 11203 is connected to the endoscope 11100 such that light generated by the light source apparatus 11203 is introduced to a distal end of the lens barrel 11101 by a light guide extending in the inside of the lens barrel 11101 and is irradiated toward an observation target in a body lumen of the patient 11132 through the objective lens. It is to be noted that the endoscope 11100 may be a direct view mirror or may be a perspective view mirror or a side view mirror.

An optical system and an image pickup element are provided in the inside of the camera head 11102 such that reflected light (observation light) from the observation target is condensed on the image pickup element by the optical system. The observation light is photoelectrically converted by the image pickup element to generate an electric signal corresponding to the observation light, namely, an image signal corresponding to an observation image. The image signal is transmitted as RAW data to a CCU 11201.

The CCU 11201 includes a central processing unit (CPU), a graphics processing unit (GPU) or the like and integrally controls operation of the endoscope 11100 and a display apparatus 11202. Further, the CCU 11201 receives an image signal from the camera head 11102 and performs, for the image signal, various image processes for displaying an image based on the image signal such as, for example, a development process (demosaic process).

The display apparatus 11202 displays thereon an image based on an image signal, for which the image processes have been performed by the CCU 11201, under the control of the CCU 11201.

The light source apparatus 11203 includes a light source such as, for example, a light emitting diode (LED) and supplies irradiation light upon imaging of a surgical region to the endoscope 11100.

An inputting apparatus 11204 is an input interface for the endoscopic surgery system 11000. A user can perform inputting of various kinds of information or instruction inputting to the endoscopic surgery system 11000 through the inputting apparatus 11204. For example, the user would input an instruction or a like to change an image pickup condition (type of irradiation light, magnification, focal distance or the like) by the endoscope 11100.

A treatment tool controlling apparatus 11205 controls driving of the energy treatment tool 11112 for cautery or incision of a tissue, sealing of a blood vessel or the like. A pneumoperitoneum apparatus 11206 feeds gas into a body lumen of the patient 11132 through the pneumoperitoneum tube 11111 to inflate the body lumen in order to secure the field of view of the endoscope 11100 and secure the working space for the surgeon. A recorder 11207 is an apparatus capable of recording various kinds of information relating to surgery. A printer 11208 is an apparatus capable of printing various kinds of information relating to surgery in various forms such as a text, an image or a graph.

It is to be noted that the light source apparatus 11203 which supplies irradiation light when a surgical region is to be imaged to the endoscope 11100 may include a light source which includes, for example, an LED, a laser light source or a combination of them. Where a light source includes a combination of red, green, and blue (RGB) laser light sources, since the output intensity and the output timing can be controlled with a high degree of accuracy for each color (each wavelength), adjustment of the white balance of a picked up image can be performed by the light source apparatus 11203. Further, in this case, if laser beams from the respective RGB laser light sources are irradiated time-divisionally on an observation target and driving of the image pickup elements of the camera head 11102 are controlled in synchronism with the irradiation timings. Then images individually corresponding to the R, G and B colors can be also picked up time-divisionally. According to this method, a color image can be obtained even if color filters are not provided for the image pickup element.

Further, the light source apparatus 11203 may be controlled such that the intensity of light to be outputted is changed for each predetermined time. By controlling driving of the image pickup element of the camera head 11102 in synchronism with the timing of the change of the intensity of light to acquire images time-divisionally and synthesizing the images, an image of a high dynamic range free from underexposed blocked up shadows and overexposed highlights can be created.

Further, the light source apparatus 11203 may be configured to supply light of a predetermined wavelength band ready for special light observation. In special light observation, for example, by utilizing the wavelength dependency of absorption of light in a body tissue to irradiate light of a narrow band in comparison with irradiation light upon ordinary observation (namely, white light), narrow band observation (narrow band imaging) of imaging a predetermined tissue such as a blood vessel of a superficial portion of the mucous membrane or the like in a high contrast is performed. Alternatively, in special light observation, fluorescent observation for obtaining an image from fluorescent light generated by irradiation of excitation light may be performed. In fluorescent observation, it is possible to perform observation of fluorescent light from a body tissue by irradiating excitation light on the body tissue (autofluorescence observation) or to obtain a fluorescent light image by locally injecting a reagent such as indocyanine green (ICG) into a body tissue and irradiating excitation light corresponding to a fluorescent light wavelength of the reagent upon the body tissue. The light source apparatus 11203 can be configured to supply such narrow-band light and/or excitation light suitable for special light observation as described above.

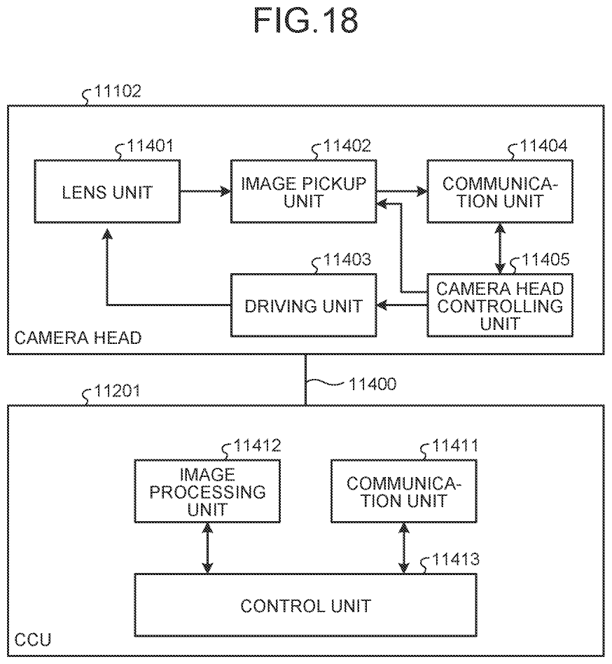

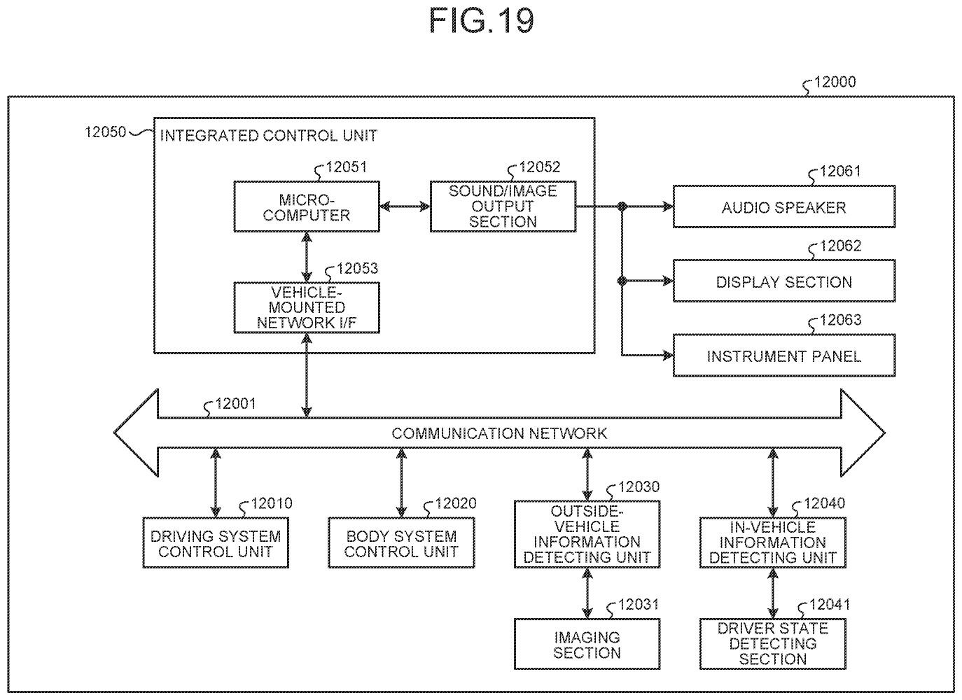

FIG. 19 is a block diagram depicting an example of a functional configuration of the camera head 11102 and the CCU 11201 depicted in FIG. 18.

The camera head 11102 includes a lens unit 11401, an image pickup unit 11402, a driving unit 11403, a communication unit 11404 and a camera head controlling unit 11405. The CCU 11201 includes a communication unit 11411, an image processing unit 11412 and a control unit 11413. The camera head 11102 and the CCU 11201 are connected for communication to each other by a transmission cable 11400.

The lens unit 11401 is an optical system, provided at a connecting location to the lens barrel 11101. Observation light taken in from a distal end of the lens barrel 11101 is guided to the camera head 11102 and introduced into the lens unit 11401. The lens unit 11401 includes a combination of a plurality of lenses including a zoom lens and a focusing lens.

The image pickup unit 11402 includes an image pickup element. The number of image pickup elements which is included by the image pickup unit 11402 may be one (single-plate type) or a plural number (multi-plate type). Where the image pickup unit 11402 is configured as that of the multi-plate type, for example, image signals corresponding to respective R, G and B are generated by the image pickup elements, and the image signals may be synthesized to obtain a color image. The image pickup unit 11402 may also be configured so as to have a pair of image pickup elements for acquiring respective image signals for the right eye and the left eye ready for three dimensional (3D) display. If 3D display is performed, then the depth of a living body tissue in a surgical region can be comprehended more accurately by the surgeon 11131. It is to be noted that, where the image pickup unit 11402 is configured as that of stereoscopic type, a plurality of systems of lens units 11401 are provided corresponding to the individual image pickup elements.

Further, the image pickup unit 11402 may not necessarily be provided on the camera head 11102. For example, the image pickup unit 11402 may be provided immediately behind the objective lens in the inside of the lens barrel 11101.

The driving unit 11403 includes an actuator and moves the zoom lens and the focusing lens of the lens unit 11401 by a predetermined distance along an optical axis under the control of the camera head controlling unit 11405. Consequently, the magnification and the focal point of a picked up image by the image pickup unit 11402 can be adjusted suitably.

The communication unit 11404 includes a communication apparatus for transmitting and receiving various kinds of information to and from the CCU 11201. The communication unit 11404 transmits an image signal acquired from the image pickup unit 11402 as RAW data to the CCU 11201 through the transmission cable 11400.

In addition, the communication unit 11404 receives a control signal for controlling driving of the camera head 11102 from the CCU 11201 and supplies the control signal to the camera head controlling unit 11405. The control signal includes information relating to image pickup conditions such as, for example, information that a frame rate of a picked up image is designated, information that an exposure value upon image picking up is designated and/or information that a magnification and a focal point of a picked up image are designated.

It is to be noted that the image pickup conditions such as the frame rate, exposure value, magnification or focal point may be designated by the user or may be set automatically by the control unit 11413 of the CCU 11201 on the basis of an acquired image signal. In the latter case, an auto exposure (AE) function, an auto focus (AF) function and an auto white balance (AWB) function are incorporated in the endoscope 11100.

The camera head controlling unit 11405 controls driving of the camera head 11102 on the basis of a control signal from the CCU 11201 received through the communication unit 11404.

The communication unit 11411 includes a communication apparatus for transmitting and receiving various kinds of information to and from the camera head 11102. The communication unit 11411 receives an image signal transmitted thereto from the camera head 11102 through the transmission cable 11400.

Further, the communication unit 11411 transmits a control signal for controlling driving of the camera head 11102 to the camera head 11102. The image signal and the control signal can be transmitted by electrical communication, optical communication or the like.

The image processing unit 11412 performs various image processes for an image signal in the form of RAW data transmitted thereto from the camera head 11102.

The control unit 11413 performs various kinds of control relating to image picking up of a surgical region or the like by the endoscope 11100 and display of a picked up image obtained by image picking up of the surgical region or the like. For example, the control unit 11413 creates a control signal for controlling driving of the camera head 11102.

Further, the control unit 11413 controls, on the basis of an image signal for which image processes have been performed by the image processing unit 11412, the display apparatus 11202 to display a picked up image in which the surgical region or the like is imaged. Thereupon, the control unit 11413 may recognize various objects in the picked up image using various image recognition technologies. For example, the control unit 11413 can recognize a surgical tool such as forceps, a particular living body region, bleeding, mist when the energy treatment tool 11112 is used and so forth by detecting the shape, color and so forth of edges of objects included in a picked up image. The control unit 11413 may cause, when it controls the display apparatus 11202 to display a picked up image, various kinds of surgery supporting information to be displayed in an overlapping manner with an image of the surgical region using a result of the recognition. Where surgery supporting information is displayed in an overlapping manner and presented to the surgeon 11131, the burden on the surgeon 11131 can be reduced and the surgeon 11131 can proceed with the surgery with certainty.

The transmission cable 11400 which connects the camera head 11102 and the CCU 11201 to each other is an electric signal cable ready for communication of an electric signal, an optical fiber ready for optical communication or a composite cable ready for both of electrical and optical communications.

Here, while, in the example depicted, communication is performed by wired communication using the transmission cable 11400, the communication between the camera head 11102 and the CCU 11201 may be performed by wireless communication.

An example of the endoscopic surgery system to which the technology according to the present disclosure can be applied has been described above. The technology according to the present disclosure can be applied to, for example, the light source apparatus 11203 in the above-described configuration.

It is to be noted that, here, the endoscopic surgery system has been described as an example, but the technology according to the present disclosure may also be applied to, for example, a microsurgical system or the like. By applying the technology of the present disclosure, it is possible to detect a difference in a small affected site, a small shape, a surface state, or the like.

### <4.3 Application Example to Mobile Body>

For example, the technology according to the present disclosure may be realized as a device mounted on any type of mobile body such as an automobile, an electric vehicle, a hybrid electric vehicle, a motorcycle, a bicycle, a personal mobility, an airplane, a drone, a ship, or a robot.

FIG. 19 is a block diagram depicting an example of schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example depicted in FIG. 50, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like. In addition, the outside-vehicle information detecting unit 12030 may include an irradiation section (not illustrated) that irradiates an object outside the vehicle with light having a predetermined wavelength.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing. In addition, the in-vehicle information detecting unit 12040 may include an irradiation section (not illustrated) that irradiates a driver in the vehicle with light having a predetermined wavelength.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 50, an audio speaker 12061, a display section 12062, and an instrument panel 12063 are illustrated as the output device. The display section 12062 may, for example, include at least one of an on-board display and a head-up display.

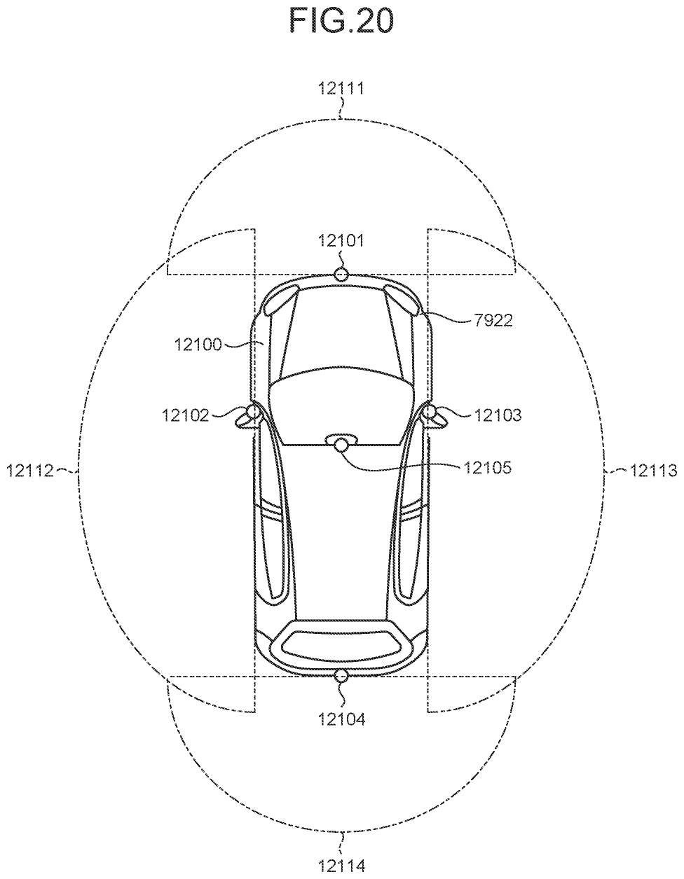

FIG. 20 is a diagram depicting an example of the installation position of the imaging section 12031.

In FIG. 20, a vehicle 12100 includes imaging sections 12101, 12102, 12103, 12104, and 12105 as the imaging section 12031.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The images of the front acquired by the imaging sections 12101 and 12105 are used mainly to detect a preceding vehicle, a pedestrian, an obstacle, a signal, a traffic sign, a lane, or the like.

Incidentally, FIG. 20 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure can be applied has been described above. The technology according to the present disclosure can be applied to, for example, an irradiation section (not illustrated) of the outside-vehicle information detecting unit 12030, an irradiation section (not illustrated) of the in-vehicle information detecting unit 12040, or the like in the configuration described above. By applying the technology of the present disclosure, it is possible to detect a situation inside and outside the vehicle 12100 in detail.

### 5. Supplement

Although the preferred embodiments of the present disclosure have been described in detail with reference to the accompanying drawings, the technical scope of the present disclosure is not limited to the examples. It is obvious that a person with ordinary knowledge in the technical field of the present disclosure can conceive various modification examples or alteration examples within the scope of the technical ideas described in the claims, and it is naturally understood that these examples also belong to the technical scope of the present disclosure.

In addition, the effects described in this specification are merely illustrative or exemplary and are not restrictive. That is, the technology according to the present disclosure can exhibit other effects obvious to those skilled in the art from the description of this specification in addition to or instead of the above-described effects.

It is to be noted that the present technology can also have the following configurations.

(1) A light emitting device comprising:
a light emitting surface configured by arranging a plurality of unit regions in a two-dimensional array, each of the unit regions including a plurality of light emitters; and
a control unit that drives the light emitters individually, wherein
each of the unit regions includes a first light emitter and a second light emitter that emit lights having wavelengths different from each other in a near-infrared region.
   (2) The light emitting device according to (1), wherein the first and second light emitters emit light having a wavelength of 850 nm to 1500 nm.
   (3) The light emitting device according to (1) or (2), wherein
each of the unit regions further includes a third light emitter that emits light having a wavelength in a near-infrared region, the wavelength being different from the wavelengths of the light emitted by the first and second light emitters, and
the control unit drives the third light emitter individually.
   (4) The light emitting device according to any one of (1) to (3), wherein
each of the unit regions includes one or a plurality of fourth light emitters that emit light in a visible light region, and
the control unit drives the fourth light emitters individually.
   (5) The light emitting device according to (4), wherein the plurality of fourth light emitters include three light emitters that emit different lights in the visible light region.
   (6) The light emitting device according to any one of (1) to (5), wherein each of the unit regions further includes one or a plurality of sensor elements that receive reflected light from a subject.
   (7) The light emitting device according to (6), wherein the sensor element is at least one of an SWIR sensor, a visible light sensor, and an EVS.
   (8) The light emitting device according to any one of (1) to (7), wherein, in each of the unit regions, the plurality of light emitters are arranged in a form of any one of a square array, a rectangular array, a stripe array, a polygonal array, and a substantially circular array.
   (9) The light emitting device according to any one of (1) to (8), wherein areas of the first light emitter and the second light emitter included in each of the unit regions are different from each other.
   (10) The light emitting device according to any one of (1) to (9), wherein the light emitter is configured of any one of an LED, an OLED, a laser element, and a liquid crystal.
   (11) The light emitting device according to any one of (1) to (10), wherein the first and second light emitters are provided adjacent to each other on a substrate.
   (12) The light emitting device according to any one of (1) to (10), wherein the first and second light emitters are provided to be stacked on each other on a semiconductor substrate.
   (13) The light emitting device according to (12), wherein
each of the unit regions includes
a plurality of color filters provided on stacked layers of the first and second light emitters.
   (14) The light emitting device according to any one of (1) to (13), wherein the control unit controls each of the light emitters to project light having a predetermined pattern onto a subject.
   (15) The light emitting device according to (14), further comprising
a projector lens that projects the light having the predetermined pattern from the light emitting surface onto a subject.
   (16) The light emitting device according to (15), wherein the projector lens enlarges or reduces the light having the predetermined pattern.
   (17) The light emitting device according to (16), wherein the control unit controls the projector lens to enlarge or reduce the light having the predetermined pattern.
   (18) The light emitting device according to any one of (1) to (17), wherein
the control unit controls the first light emitter and the second light emitter to emit light at different timings.
   (19) The light emitting device according to any one of (1) to (17), wherein the control unit controls the first and second light emitters to simultaneously emit light in a predetermined period.
   (20) An electronic apparatus equipped with a light emitting device, wherein
the light emitting device includes:
a light emitting surface configured by arranging a plurality of unit regions in a two-dimensional array, each of the unit regions including a plurality of light emitters; and
a control unit that drives the light emitters individually, and
each of the unit regions includes a first light emitter and a second light emitter that emit lights having wavelengths different from each other in a near-infrared region.

### REFERENCE SIGNS LIST

10 LIGHTING DEVICE
20 CAMERA
50 SUBJECT
60 PATTERN LIGHT
80 STEREOSCOPIC IMAGE
100 LIGHT EMITTING UNIT
102 SUBSTRATE
104a, 104b, 104c COLOR FILTER
200, 200a, 200b, 200c, 200d, 200e, 200f, 200g BLOCK UNIT
202a, 202b, 202c, 202d, 204b, 204g, 204r LIGHT EMITTING ELEMENT
210 SENSOR
300 LENS
400 CONTROL UNIT

1. A light emitting device comprising:
a light emitting surface configured by arranging a plurality of unit regions in a two-dimensional array, each of the unit regions including a plurality of light emitters; and
a control unit that drives the light emitters individually, wherein
each of the unit regions includes a first light emitter and a second light emitter that emit lights having wavelengths different from each other in a near-infrared region.

2. The light emitting device according to claim 1, wherein the first and second light emitters emit light having a wavelength of 850 nm to 1500 nm.

3. The light emitting device according to claim 1, wherein
each of the unit regions further includes a third light emitter that emits light having a wavelength in a near-infrared region, the wavelength being different from the wavelengths of the light emitted by the first and second light emitters, and
the control unit drives the third light emitter individually.

4. The light emitting device according to claim 1, wherein
each of the unit regions includes one or a plurality of fourth light emitters that emit light in a visible light region, and
the control unit drives the fourth light emitters individually.

5. The light emitting device according to claim 4, wherein the plurality of fourth light emitters include three light emitters that emit different lights in the visible light region.

6. The light emitting device according to claim 1, wherein each of the unit regions further includes one or a plurality of sensor elements that receive reflected light from a subject.

7. The light emitting device according to claim 6, wherein the sensor element is at least one of an SWIR sensor, a visible light sensor, and an EVS.

8. The light emitting device according to claim 1, wherein, in each of the unit regions, the plurality of light emitters are arranged in a form of any one of a square array, a rectangular array, a stripe array, a polygonal array, and a substantially circular array.

9. The light emitting device according to claim 1, wherein areas of the first light emitter and the second light emitter included in each of the unit regions are different from each other.

10. The light emitting device according to claim 1, wherein the light emitter is configured of any one of an LED, an OLED, a laser element, and a liquid crystal.

11. The light emitting device according to claim 1, wherein the first and second light emitters are provided adjacent to each other on a substrate.

12. The light emitting device according to claim 1, wherein the first and second light emitters are provided to be stacked on each other on a semiconductor substrate.

13. The light emitting device according to claim 12, wherein
each of the unit regions includes
a plurality of color filters provided on stacked layers of the first and second light emitters.

14. The light emitting device according to claim 1, wherein the control unit controls each of the light emitters to project light having a predetermined pattern onto a subject.

15. The light emitting device according to claim 14, further comprising
a projector lens that projects the light having the predetermined pattern from the light emitting surface onto a subject.

16. The light emitting device according to claim 15, wherein the projector lens enlarges or reduces the light having the predetermined pattern.

17. The light emitting device according to claim 16, wherein the control unit controls the projector lens to enlarge or reduce the light having the predetermined pattern.

18. The light emitting device according to claim 1, wherein
the control unit controls the first light emitter and the second light emitter to emit light at different timings.

19. The light emitting device according to claim 1, wherein the control unit controls the first and second light emitters to simultaneously emit light in a predetermined period.

20. An electronic apparatus equipped with a light emitting device, wherein
the light emitting device includes:
a light emitting surface configured by arranging a plurality of unit regions in a two-dimensional array, each of the unit regions including a plurality of light emitters; and
a control unit that drives the light emitters individually, and
each of the unit regions includes a first light emitter and a second light emitter that emit lights having wavelengths different from each other in a near-infrared region.
